(19) United States
(12) Patent Application Publication
(10) Pub. No.: US 2020/0087217 A1
(43) Pub. Date: Mar. 19, 2020

(54) DYE MIXTURE FOR DETERMINING THE READINESS FOR COVERING OF LEVELLING COMPOUNDS

(71) Applicant: Uzin Utz AG, Ulm (DE)

(72) Inventors: Timo Joechle, Laichingen (DE); Markus Gretz, Guenzburg (DE); Alexander Jung, Neu-Ulm (DE); Johannis Tsalos, Ulm (DE)

(73) Assignee: Uzin Utz AG, Ulm (DE)

(21) Appl. No.: 16/519,766

(22) Filed: Jul. 23, 2019

(30) Foreign Application Priority Data
Jul. 23, 2018 (EP) 18184950.6

(51) Int. Cl. C04B 41/45; C09D 7/20; C09D 7/41; C04B 41/46; C04B 41/62

(52) U.S. Cl. CPC C04B 41/4535; C09D 7/20; C04B 41/62; C04B 41/46; C09D 7/41

(57) ABSTRACT

The present invention relates to a dye mixture for determining the readiness for covering of levelling compounds, and also an application device which includes such a dye mixture. The present invention further relates to the use of the dye mixture for determining the readiness for covering of levelling compounds.

### FIELD OF THE INVENTION

The present invention relates to a dye mixture for determining the readiness for covering of levelling compounds, and also an application device which comprises such a dye mixture. The present invention further relates to the use of the dye mixture for determining the readiness for covering of levelling compounds.

### TECHNICAL BACKGROUND

The laying of floor coverings such as PVC coverings, rubber coverings, textile coverings or parquet places particular demands on the substrate. Screeds/levelling compounds are used for levelling out unevennesses in floors and raw floors. These serve, inter alia, to effect levelling or for a constant absorption capability of the substrate. The absorption capability is, in particular, of great importance for subsequent adhesive bonding of floor coverings using aqueous adhesive systems (e.g. dispersion adhesives).

Levelling compounds and screeds are frequently marketed as factory-mixed dry mortars. Factory-formulated dry mortar systems are formulated powder products which are mixed with water before application and thereby attain a workable consistency.

Binders used in levelling compounds/screeds are predominantly mineral materials. These react in dissolution and crystallization processes on being brought into contact with water to form hydration products which are responsible for the strength of building materials. As binders in levelling compounds, use is made of, inter alia, cement-based binders (e.g. portland cement, composite cements, high-alumina cements), lime or gypsum (calcium sulphate binder) in various modifications (e.g. anhydrite, hemihydrate). Combinations of various mineral binders are frequently used in levelling compounds. Apart from the mineral binders, the levelling compounds described contain fillers (e.g. sand, limestone powder), polymers (e.g. redispersible dispersion powders) and also organic and inorganic additives for controlling the processing and product properties.

Ensuring rapid progress of building work is a main demand made of levelling compounds/screeds. Functional, damage-free laying of floor coverings on the abovementioned substrates is essential. To achieve functional, damage-free laying of floor coverings, the substrate has to have a sufficiently low residual moisture content. This is particularly true in the laying of vapour-impermeable coverings (e.g. PVC, rubber). After such coverings have been laid, water which is not chemically and/or physically bound can escape only extremely slow from the substrate and when continuing to act can lead to damage to the substrate and to a reduction in the technical functionality through to complete failure of the adhesive bond (e.g. bubble formation, detachment). The readiness for covering of a levelling compound corresponds to the period of time between application of the levelling compound and the point in time after which functional adhesive bonding of floor coverings is possible. When the readiness for covering has been attained, the system has a sufficiently low residual moisture content which can be compensated for by the levelling compound as such, so that no damage to the adhesive bond occurs.

To attain the processing consistency, dry mortar systems are mixed with an excess of mixing water. This means that there is more water available than the binder system requires for setting and for forming the hydration products. Excess water thus has to be given off via the surface to the surroundings by evaporation and/or be taken up by the substrate.

Cement-based products differ significantly in terms of their dry time, namely the time until they are ready to cover, from gypsum-based products, but even within the group of cement-based binder systems and within the group of gypsum-based binder systems there are differences depending proportion of binder and binder composition; thus, there are, for example, cement-based fast-processing products which are ready to cover after 1 hour (e.g. Uzin NC 172 BiTurbo, Uzin Utz AG, Ulm, Germany), but also cement-based and gypsum-based products which are ready to cover only after 24 hours.

It is therefore not easy for a person performing the laying to see when a levelling compound is dry enough for further laying work. This depends mainly on the type and composition of the binder.

In order therefore to indicate the readiness for covering of screeds/levelling compounds accurately, it would be desirable to have a system which indicates the readiness for covering in a simple way and without complicated analytical systems. A person skilled in the art usually relies on the technical product data sheets of the manufacturers, but here the times indicated are generally based only on standard conditions (e.g. 20° C., 65% rel. atmospheric humidity), so that differences can occur in practical use under different climatic conditions.

There is already, for example, a product which is based on cement and indicates the readiness for covering by means of a particular colour change, namely the screed bonding cement Ardex A 18 (Ardex GmbH, Witten, Germany). However, this bonding slurry is provided with pigment and after drying changes merely from dark green to light green.

Furthermore, WO 2008/003672 A1 describes a render or a powder coating in which a colour change on complete drying is generated by phenolphthalein and/or thymolphthalein. In this system, the colour changes from pinkish violet in the wet state to white on complete drying.

It is therefore an object of the invention to provide a dye mixture and an application device for this which can be used for simple and reliable determination of the readiness for covering of levelling compounds.

### DESCRIPTION OF THE INVENTION

This object is achieved according to the invention by a dye mixture for determining the readiness for covering of levelling compounds, which dye mixture comprises at least one sparingly water-soluble dye and at least one readily water-soluble dye.

According to the invention, chromatographic separation of at least two dyes after application to the levelling compounds makes it possible to see whether free, damaging water is present in the levelling compound microstructure to be tested. The dye mixture is applied to the levelling compound to be tested by means of an application device, for example a pen. The dyes present in the dye mixture are chromatographically separated by the residual moisture of the levelling compound.

Chromatography is understood to mean a process in which mixtures of materials are separated by means of interactions of different strengths between individual constituents and a stationary phase and a mobile phase. The stronger the interaction between a substance and the mobile phase, the more quickly or further is the substance transported through the stationary phase. In the present case, any free water in the levelling compound serves as mobile phase and the porous microstructure of the set levelling compound serves as stationary phase.

The evaporation of water in the upper region of an applied levelling compound produces a moisture gradient over the cross section thereof. To counter this gradient, free water is transported by capillary forces from the lower regions of the levelling compound in the direction of the surface where the water spreads out further and then evaporates again. This effect continues until an equilibrium of the moisture content, known as the equilibrium moisture content, has become established over the full cross section and also to the surroundings (the air of the room).

If a dye mixture comprising at least one sparingly water-soluble dye and at least one readily water-soluble dye is now applied to the levelling compound which is not yet ready for covering, the readily water-soluble dye is separated from the sparingly water-soluble dye by the capillary transport of the free water (the mobile phase) to the surface. When only very little free water or no free water is present in the levelling compound, the flow of the mobile phase is too low to effect separation of the substances. This is an indication that the levelling compound is ready for covering.

The present invention gives the person performing the laying a simple tool which makes the readiness for covering of a levelling compound visible on building sites. In the case of thin layers (less than 5 mm), the advantage is, in particular, simple, quick and destruction-free application. In the case of thicker layers, scoring of the surface can additionally ensure that the entire cross section is measured. It is therefore even possible to look specifically at the lower region of a relative thick layer, should this be necessary. The slight damage to the surface of the levelling compound can be repaired by means of a firm levelling compound before further laying work.

In a first aspect, the present invention thus provides a dye mixture for determining the readiness for covering of levelling compounds, comprising at least one sparingly water-soluble dye and at least one readily water-soluble dye.

The readiness for covering of a substrate corresponds to the period of time between application of the levelling compound and the point in time after which functional adhesive bonding of coverings, preferably floor coverings, it possible. In general, peel values of greater than 0.6 N/mm after 24 hours after adhesive bonding are necessary for a functional, damage-free adhesive bond. Furthermore, these values should increase continuously and preferably be at least 1 N/mm (after 4 days after adhesive bonding).

The readiness for covering of the levelling compound is thus by definition achieved when a peel value of at least 0.6 N/mm (e.g. 0.7 N/mm, 0.8 N/mm or 0.9 N/mm) is attained within 24 hours after adhesive bonding and a peel value of at least 1 N/mm (e.g. 1.1 N/mm, or 1.2 N/mm) is attained after within 96 hours after adhesive bonding. If the adhesive is applied before the levelling compound is ready for covering, the abovementioned values are not achieved.

To assess the readiness for covering, the levelling compounds are applied in a layer thickness of, for example 3 mm. Here, it is possible to choose, for example, the following procedure: as substrate, use is made of a concrete substrate which has been pretreated with a 1-component rapid reactive primer which slows the passage of water vapour (e.g. UZIN PE 414 Turbo) and a dispersion-based bonding agent (e.g. Uzin PE 280) for the subsequent levelling operation. For example, a concrete slab (e.g. 40 cm×40 cm) is provided. The priming can be carried out in the following steps: the slab is firstly prepainted with, for example, 250-350 g/m² of the 1-component rapid reactive primer which slows the passage of water vapour. Priming can be carried out in two layers applied transversely to one another, with the drying time being able to be 2 hours in each case. A dispersion primer (e.g. Uzin PE 280), which serves as bonding layer for the subsequent levelling operation, can be applied thereto. The drying time can be about 1 hour.

The levelling compound which has been mixed with water is then applied in a layer thickness of about 2-4 mm, preferably 2.5 mm or 3 mm, to the concrete slab which has been pretreated as described above. The drying time of the levelling compound can vary in the range from 1 to 48 hours.

Relatively vapour-impermeable floor coverings are then applied by adhesive bondings. For the adhesive bonding of PVC (e.g. Armstrong DLW Royal), a dispersion-based pressure-sensitive adhesive (e.g. UZIN KE 2000S) is, for example, applied in an amount of about 300 g/m², e.g. using a trowel. Rubber coverings (e.g. Nora Noraplan Mega) are, for example, adhesively bonded using a wet-bed dispersion adhesive (e.g. UZIN KE 66).

Strips of covering (width: 5×25 cm) are then peeled off from the substrate by means of a spring balance at various times after adhesive bonding and the peel values (in N/mm) are thus determined.

The determination of the peel value is carried out by a method based on the standard EN1372:2015 “Test method for adhesives for floor and wall coverings—peel test”. To simplify the method, a spring balance is used manually instead of the roller shear device (automated testing machine) provided for in the standard in order to peel off the floor coverings manually.

The peel force is then assessed at various points in time, e.g. 4, 6, 8, 10, 12, 14, 16, 20, 24 or 26 to 96 hours after adhesive bonding. One or more strips of covering are pulled off using a force meter (e.g. a spring balance) at each measurement point.

If, for example, the levelling compound on the concrete substrate has strips of covering adhesively bonded thereto after a drying time of, for example, 4 hours and a peel value of 0.5 N/mm is achieved after 24 hours, this would mean that readiness for covering has not yet been attained at the point in time of adhesive bonding.

The dye mixture of the invention is intended to enable the readiness for covering as indicated above to be determined simply and reliably.

In this dye mixture, the term “sparingly water-soluble dye” is intended to mean, in a preferred embodiment, that the dye has a solubility of <10 g/l, particularly preferably <1 g/l. The solubility in water of a dye is usually measured at 15-25° C. and at a given pH.

The term “readily water-soluble dye” means, in a further preferred embodiment, that the dye has a solubility in water of >30 g/l, particularly preferably >50-100 g/l. Here too, the solubility in water of a dye is usually measured 15-25° C. and a given pH.

The solubility in water of a dye can change as a function of the pH. To determine a dye having a suitable solubility in water, it is thus necessary to set a specific pH or pH range. This pH or pH range depends on the specific levelling compound for which the readiness for covering is to be determined. In general, this pH will be in the range from pH 7 to 14, preferably in the range from 8 to 13, for example pH 10 or 11.

The pH of the levelling compound can, for example, be determined by applying a drop of water onto the surface of the levelling compound and, after a delay time of about 60 seconds, dipping a commercial pH strip into the drop of water.

Apart from the above, the dyes used according to the invention are not subject to any restrictions in respect of type. For the invention to function, it is entirely sufficient for the at least one sparingly water-soluble dye and the at least one readily water-soluble dye to have a sufficiently large difference in their solubility in water (see above). The two dyes ideally also differ in colour, so that the chromatographic separation of the two dyes can readily be verified visually.

According to the invention, chromophoric or auxochromic dyes, in particular, are employed. Chromophoric dyes have basic structures which contain delocalizable electrons. The type of the chromophores influences, via its absorption maximum, the colour shade of the dye, while the abundance of the chromophores influences the depth of colour. A further increase in the colouring effect can be achieved by means of functional groups which act as electron donors or electron acceptors and increase the mesomeric effect in the molecule by pushing electrons towards or away from the chromophoric group.

The dyes used according to the invention can, as a function of their chemical structure, also be divided into nitro, nitroso, azo, diarylmethane and triarylmethane, acridine, xanthene, quinonimine, azine, oxazine, methine, aza[18]annulene, carbonyl, stilbene and sulfur dyes.

A dye mixture according to the invention can, for example, contain at least one sparingly water-soluble dye from the group of xanthene dyes or azo dyes, and/or at least one readily water-soluble dye from among monoazo dyes or xanthene dyes. The dye mixture can also be present in dry form (powder form) and optionally be slurried/dissolved by means of a suitable solvent shortly before use. Table 1 shows chemical properties of various illustrative colorants:

TABLE 1

| | Chemical properties of the colorants - taken from safety data sheets - | | | | | | | |
|---|---|---|---|---|---|---|---|---|
| | | | Basacid | Basacid | Sepisol | Sepisol | Sepisol | Sepisol |
| | | | rot 495 | blau 762 | Fast Red | Fast | Fast Red | Fast blau |
| | Eosin Y | Flourescein | liquid | liquid | SN | Black CN | SB | ARN |
| Form | Solid | Powder | Liquid | Liquid | Powder | Powder | Powder | Powder |
| | (powder) | | | | | | | |
| Colour | Red- | Red | Red | Dark blue | Dark red | Black | Pink | Blue |
| | reddish | | | | | | | |
| | brown | | | | | | | |
| Odour | Odour- | No data | Odour- | Product- | Odour- | Odour- | Odour- | Odour- |
| | less | available | less | specific | less | less | less | less |
| pH: | 9.2 | No data | 6.5-8.5 | 7.5-8.5 | 7 | 7.3 | 5.0-7.0 | 8.0-9.5 |
| | (10 g/l, | available | (10 g/l, | (100 g/l, | | (10 g/l, | | |
| | 20° C.) | | 20° C.) | 20° C.) | | 20° C.) | | |
| Boiling point: | No | No data | About | About | >240° C. | No data | No data | No data |
| | information | available | 100° C. | 100° C. | | | | |
| | available | | (1013 hPa) | | | | | |
| Density | No | No data | About | About | 7.4 | No data | ~0.6 | ~0.6 |
| | information | available | 1.10 g/cm³ | 1.10 g/cm³ | g/cm³ | | kg/dm³ | kg/dm³ |
| | available | | (20° C.) | | | | | |
| Relative | No | No data | About | About | — | 0.69 | No data | |
| density: | information | available | 1.10 | 1.10 | | | | |
| | available | | (20° C.) | (20° C.) | | | | |
| Bulk density | ~710 | No data | — | — | — | No data | | |
| | kg/m³ | available | | | | | | |
| Solubility in | ~300 g/l at | Virtually | Miscible | Miscible | <0.002 | 0.01 | Insoluble | Insoluble |
| water: | 20° C. | insoluble | | | g/l | mg/l | | |
| Partition | −1.68 | No data | Study is | Not | >4 log | 5.7 | No data | No data |
| coefficient | (ECHA) | available | not | applicable | POW | (22° C.) | | |
| between | | | successful | | | log KOW | | |
| n-octanol/water | | | | | | | | |
| (log Kow): | | | | | | | | |
| Viscosity, | Not | No data | | About 80 | No data | No data | No data | No data |
| dynamic | relevant | available | | mPa · s | | | | |
| | (solid) | | | (20° C.) | | | | |

In a further embodiment, it is also possible to use two or more coloured pigments which can be separated on the basis of their particle size and their chemical and/or physical properties after application to the levelling compound.

The dye mixture can also contain a solvent in which the dyes are slurried/dissolved. This solvent is preferably selected from among water, alcohol, in particular ethanol, or mixtures thereof. Water is particularly preferred.

In a second aspect, the present invention provides an application device containing a dye mixture as described above. This application device can have a conventional structure, for example in the form of a pen, a brush or a pipette, in which the dye mixture is present in ready-to-use form or is taken up from a suitable vessel. For example, in the case of a brush or a pipette, each can be integrated into a vessel which contains the dye mixture according to the invention and optionally a suitable solvent.

The application device of the invention can also be, for example, in the form of a felt-tip pen. The core of the felt-tip pen is surrounded by a sheath which is equipped with a cap to protect against drying out. The tip of the felt-tip pen transports the dye mixture from the reservoir of the core to the surface of a levelling compound which is to be tested for its readiness for covering. The tip of the felt-tip pen can be made of felt or of polymer having defined capillaries.

In a further aspect, the present invention provides the use of the dye mixture as described above for determining the readiness for covering of levelling compounds and also a corresponding method of use.

Such a method for determining the readiness for covering of levelling compounds comprises the following steps:

a) providing a dye mixture according to the invention or an application device according to the invention,

b) applying the dye mixture to a levelling compound and allowing it to act for a defined period of time, and

c) establishing whether separation of the dyes present in the dye mixture has taken place.

Separation of the dyes present in the dye mixture indicates that the levelling compound is not ready for covering, while absence of separation of the dyes present in the dye mixture indicates that the levelling compound is ready for covering.

The time for which the dye mixture is allowed to act is generally 1-60 minutes, preferably 2-30 minutes.

The following figures and the following examples serve to illustrate the invention.

### BRIEF DESCRIPTION OF THE FIGURES

FIG. 1 shows the chromatographic separation of dye mixtures on a levelling compound containing residual moisture.

FIG. 2: Dye mixture at the point in time of 1st bonding (readiness for covering not attained).

FIG. 3: Dye mixture at the point in time of 2nd bonding (readiness for covering attained).

FIG. 4: Dye mixture at the point in time of 3rd bonding (readiness for covering attained).

### EXAMPLES

An illustrative dye mixture of the two colorants Basacid Rot 495 liquid and Sepisol Fast Black CN was made up and introduced into an empty ballpoint pen. The composition of the dye mixture was as follows: 81.9% by weight of Basacid Rot 495 liquid/16.4% by weight of EtOH 96%/1.7% by weight of Sepisol fast Black CN.

The functionality of chromatographic separation in the presence of residual moisture in a levelling compound was tested on a plurality of samples of the gypsum levelling compound UZIN NC 110 NEU having a thickness of about 3 cm. The samples poured into plastic beakers were taken from the beakers after 1 day, after 5 days and after 10 days and halved in the middle. The pen was subsequently applied over the entire cross section of the compound.

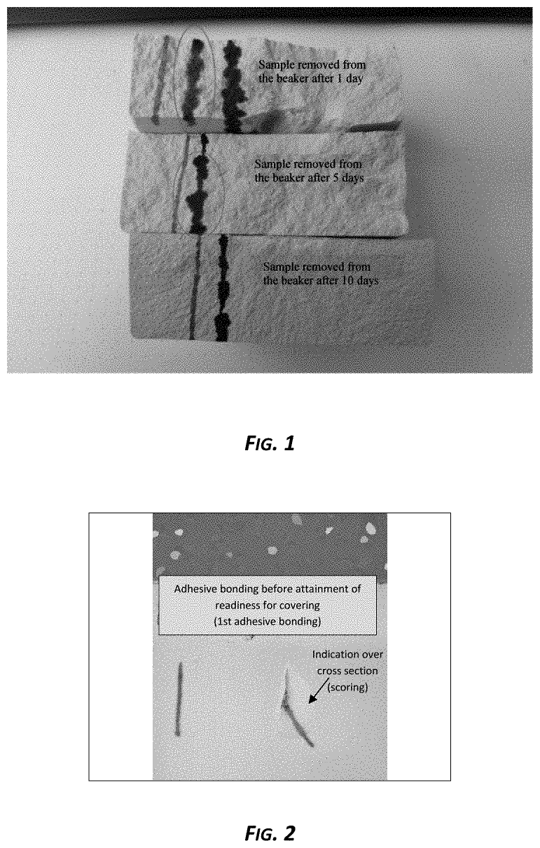

FIG. 1 shows the result of the 3 samples, with the uppermost sample having been removed from the beaker after one day, the middle sample after 5 days and the bottom sample after 10 days. The blue line on the left was applied using a commercial pen and serves as reference. The indicator substance described was in each case applied second and is thus directly to the right of the blue substance. The third line, which is only present on the first test specimen, is a mixture of Basacid Blau 762 liquid and Basacid Rot 495 liquid (mixture 50/50 by weight).

After drying for 1 day, a large amount of residual moisture is still present in the system.->Distinct separation over the entire cross section.

After 5 days, significantly less residual moisture is present in the system.->Slight separation takes place only in the lower region of the levelling compound.

After 10 days, separation is no longer visible.->The system is ready for covering.

The dye mixture described makes it possible to make damaging residual moisture in a levelling compound system visible and thus establish readiness for covering.

### Example 2

In the following examples, the readiness for covering is determined on a gypsum-based, self-levelling compound by means of a dye mixture according to the invention.

To assess the readiness for covering, the following procedure was selected: Levelling compounds/screeds were applied in a layer thickness of about 3 mm. A concrete substrate which had been pretreated with a one-component rapid reactive primer which slowed passage of water vapour (UZIN PE 414 Turbo) and a dispersion-based bonding agent (Uzin PE 280) was selected as substrate.

In the following tables, the readiness for covering determined using a pen containing a dye mixture for chromatographic separation is compared with the readiness for covering determined by the above-described method. The dye mixture present in the pen comprises a sparingly water-soluble dye and a readily water-soluble dye. Testing was carried out before the expected readiness for covering (1st adhesive bonding), on attainment of readiness for covering (2nd adhesive bonding) and at a later point in time after readiness for covering (3rd adhesive bonding, positive sample).

TABLE 2

| Pen with dye mixture | Peel value after 24 h | Peel value after 72 h |
|---|---|---|
| Chromatographic separation | 0.0 N/mm² | 0.1 N/mm² |
| of the dyes visible over the | | |
| full area. (FIG. 2) | | |
| → Readiness for covering | | |
| not yet attained | | |

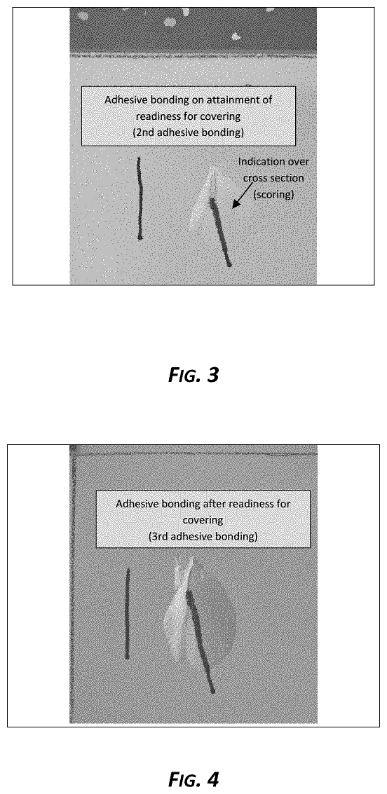

TABLE 3

| Pen with dye mixture | Peel value after 24 h | Peel value after 72 h |
|---|---|---|
| Chromatographic separation | 0.8 N/mm² | 1.2 N/mm² |
| of the dyes no longer takes | | |
| place. (FIG. 3) | | |
| → Readiness for covering | | |
| attained | | |

TABLE 4

| Pen with dye mixture | Peel value after 24 h | Peel value after 72 h |
|---|---|---|
| Chromatographic separation | 1.1 N/mm² | 1.4 N/mm² |
| of the substances no longer | | |
| takes place. (FIG. 4) | | |
| → Readiness for covering | | |
| attained | | |

The series of experiments shows that the readiness for covering of the levelling compound can be indicated by means of the proposed pen. It becomes possible to see that a large amount of free water is initially present in the levelling compound microstructure (point in time 1: FIG. 2). The insufficient development of peel strength in the experimental determination of the readiness for covering demonstrates that readiness for covering had actually not yet been attained.

At the 2nd point in time (FIG. 3) and also at the point in time 3 (FIG. 4) it can be seen that no or only very little free water is present in the microstructure.

The adhesive bonding tests demonstrate, by means of a peel strength development (see Table 3 and 4) which is necessary for functional and damage-free adhesive bonding, the functionality of the adhesive bond and thus confirm the readiness for covering.

The 3rd adhesive bonding was carried out at a point in time after the readiness for covering had been determined (positive sample), i.e. the levelling compound can in every case be covered functionally and without damage by a floor covering. The dye mixture indicates readiness for covering at this point in time (no chromatographic separation). The peel strength development likewise indicates that the levelling compound was ready for covering.

1. A dye mixture for determining readiness for covering of levelling compounds, comprising at least one sparingly water-soluble dye and at least one readily water-soluble dye.

2. The dye mixture according to claim 1, wherein the at least one sparingly water-soluble dye has a solubility in water of <10 g/l.

3. The dye mixture according to claim 1, wherein the at least one readily water-soluble dye has a solubility in water of >30 g/l.

4. The dye mixture according to claim 1, wherein the at least one sparingly water-soluble dye and/or the at least one readily water-soluble dye is/are selected from the group consisting of chromophoric dyes and auxochromic dyes.

5. The dye mixture according to claim 1, wherein the at least one sparingly water-soluble dye is selected from the group consisting of xanthene dyes and azo dyes and/or wherein the at least one readily water-soluble dye is selected from the group consisting of monoazo dyes and xanthene dyes.

6. The dye mixture according to claim 1, wherein the dye mixture further comprises a solvent in which the dyes are slurried and/or dissolved.

7. The dye mixture according to claim 6, wherein the solvent is selected from the group consisting of water, alcohol, and mixtures thereof.

8. An application device containing a dye mixture according to claim 1.

9. The application device according to claim 8, which is in the form of a pen, a brush, or a pipette.

10. (canceled)

11. A method for determining the readiness for covering of levelling compounds, comprising the steps:
(a) providing a dye mixture according to claim 1;
(b) applying the dye mixture to a levelling compound and allowing it to act for a defined period of time; and
(c) establishing whether separation of the dyes present in the dye mixture has taken place.

12. The method according to claim 11, wherein separation of the dyes present in the dye mixture indicates that the levelling compound is not ready for covering and the absence of separation of the dyes present in the dye mixture indicates that the levelling compound is ready for covering.

13. The dye mixture according to claim 2, wherein the at least one sparingly water-soluble dye has a solubility in water of <1 g/l.

14. The dye mixture according to claim 3, wherein the at least one readily water-soluble dye has a solubility in water of >50 g/l.

15. The dye mixture according to claim 7, wherein the solvent ethanol.

16. The method of claim 11, wherein the dye mixture is present in an application device.

17. The method of claim 16, wherein the application device is in the form of a pen, a brush, or a pipette.
